(19) United States
(12) Patent Application Publication
(10) Pub. No.: US 2012/0224906 A1
(43) Pub. Date: Sep. 6, 2012

(54) PRINTER

(75) Inventor: Kiyotaka Nihashi, Shizuoka (JP)

(73) Assignee: TOSHIBA TEC KABUSHIKI KAISHA, Tokyo (JP)

(21) Appl. No.: 13/406,879

(22) Filed: Feb. 28, 2012

(30) Foreign Application Priority Data
Mar. 2, 2011 (JP) 2011-45505

(51) Int. Cl. B41J 15/00

(52) U.S. Cl. 400/611

(57) ABSTRACT

Embodiments described herein are to a printer which includes a printer body, a roll receiving unit, a printing unit, and a holding unit. The roll receiving unit is located within the printer body to receive a paper roll. The printing unit includes a platen and a print head facing the platen. The printing unit transfers the print paper being withdrawn from the paper roll receiving unit by the rotation of the platen, and performs a printing operation by the print head. The holding unit holds the paper roll at a predetermined position when the paper roll becomes lighter than a predetermined weight.

### CROSS-REFERENCE TO RELATED APPLICATION

This application is based upon and claims the benefit of priority from Japanese Patent Application No. 2011-045505, filed on Mar. 2, 2011, the entire contents of which are incorporated herein by reference.

### FIELD

Embodiments described herein relate generally to a printer that performs a printing operation using a roll type linerless label.

### BACKGROUND

In a printer, a roll type paper (hereinafter, referred to as a paper roll) is received in a receiving unit, and a printing operation is performed by withdrawing the paper from the receiving unit and supplying the withdrawn paper between a thermal head and a platen roller. The paper is withdrawn by the rotation of the platen roller, which causes the paper roll inside the receiving unit to be rotated.

Meanwhile, when a new paper roll is first loaded into the receiving unit, it may be difficult for the paper roll to rotate when the paper is withdrawn because the loaded paper roll has a large outer diameter and has a significant weight, which causes a large inertial force downward inside the receiving unit. This also lowers the paper transfer speed on the platen and causes a printing failure such as smudgy printing.

Therefore, a damper that is elastically biased by a spring or the like is installed at a paper roll withdrawal side, so that a withdrawn portion of the paper is pulled downward by the damper, causing the withdrawn portion of the paper to be bent downward. In this configuration, when the paper is withdrawn, the damper moves against the biasing force of the spring and discharges the bent portion of the paper, thereby preventing a delay in the conveyance of the paper on the platen.

In addition, as the paper roll is consumed, the outer diameter of the paper roll is reduced and weighs less. This reduces the downward inertia force of the paper roll and the conveyance delay of the paper on the platen. Thus, the damper returns back to the initial position by the biasing force of the spring.

However, when a linerless label is used as a paper roll, as the outer diameter of the paper roll is reduced by consumption thereof and the paper roll weighs less, there may be a problem in that an abnormal noise is generated while the paper roll is rattling inside the receiving unit.

Specifically, the linerless label has a print surface on one side thereof and an adhesive coated surface on the other side. Thus, if the paper roll becomes light as it is consumed, the paper roll may adhere to the damper and thus be lifted up as the damper moves upward. If the paper roll is lifted up in this way, the paper roll may collide with a guide or the like in the vicinity of the damper. On the other hand, if the adhesive coated on the paper peels off, the paper roll may fall into a hopper. This causes the paper roll to collide with the bottom or side of the hopper and thus generate an abnormal noise.

In particular, if the printing speed, i.e., the paper transfer speed increases, the paper roll may move up and down within the hopper and thus generate noise more frequently.

### BRIEF DESCRIPTION OF THE DRAWINGS

FIG. 1 is a sectional side view showing a printer installed on a table according to a first embodiment.

FIG. 2 is a sectional side view showing a state in which the printer of FIG. 1 is installed on a wall.

FIG. 3 is a sectional side view showing a printer according to a second embodiment.

FIG. 4 is a view showing an internal configuration of a printer according to a third embodiment.

### DETAILED DESCRIPTION

According to one embodiment, a printer includes a printer body, a roll receiving unit, a printing unit, and a holding unit. The roll receiving unit is installed within the printer body to receive a paper roll. The printing unit includes a platen and a print head facing the platen. The printing unit transfers the paper roll being withdrawn from the paper roll receiving unit by the rotation of the platen, and performs a printing operation by the print head. The holding unit holds the paper roll at a predetermined position when the paper roll becomes lighter than a predetermined weight.

Embodiments will now be described in detail with reference to the drawings.

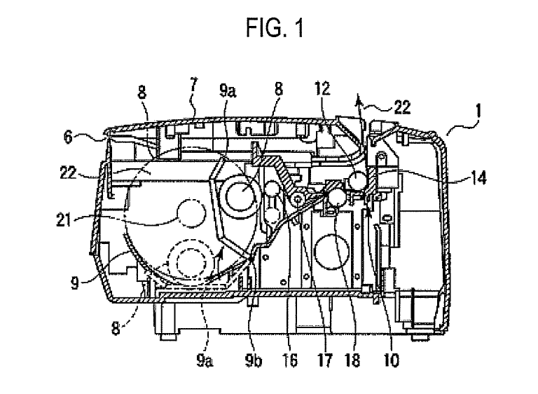

FIG. 1 is a sectional side view showing an internal configuration of a printer according to a first embodiment.

The printer prints information on an elongated print paper wound in a roll shape and includes a printer body 1 which may be installed either in a horizontal direction or in a vertical direction. Specifically, the printer body 1 may be installed in a horizontal direction on a table or in a vertical direction on a wall surface. FIG. 1 shows when the printer body 1 is installed on⁻ a table in a horizontal direction.

The printer body 1 includes an open/close cover 7 that is openable and closable around a hinge 6. In the inside of the printer body 1, a holding unit such as a hopper 9 is installed as a paper roll receiving unit configured to receive a paper roll 8, and a printing unit 10 is installed as a printing means. The paper roll 8 is formed by winding an elongated linerless label 22 around a roll core 21 in a roll. One surface of the linerless label 22 is a print surface, and the other surface of the linerless label 22 is an adhesive surface.

The printing unit 10 is provided with a platen 12 rotated by a platen motor, and a thermal head 14 as a print head configured to pressure-contact the platen 12 through the linerless label 22 by a biasing force of a head spring (not shown). The linerless label 22 is transferred by the rotation of the platen 12. At a downstream side of the printing unit 10, a cutter (not shown) driven by a cutter motor is installed.

In addition, a damper 16 and guide rollers 17 and 18 are sequentially installed between the hopper 9 and the printing unit 10 along a transfer direction of the linerless label 22. The linerless label 22 withdrawn from the hopper 9 is hung on the damper 16 and the guide rollers 17 and 18 and is supplied between the platen 12 and the thermal head 14. The damper 16 is elastically biased upward by a spring (not shown), causing a portion of the linerless label 22 to be bent.

Meanwhile, the hopper 9 has a bottom part 9a as a holding means facing a bottom surface of the paper roll 8. The bottom part 9a is supported through a support shaft 9b and is elastically biased by a spring (not shown) such that it is pivoted upward around the support shaft 9b.

For loading the paper roll 8 into the hopper 9, an operator opens the open/close cover 7 of the printer body 1, places the bottom part 9a at the bottom of the printer body 1 by pivoting the bottom part 9a downward against the biasing force of the spring, and loads the paper roll 8 thereon. The loaded paper roll 8 in an unused state has the largest outer diameter of the paper roll 8 giving it significant weight. Therefore, the bottom part 9a of the hopper 9 remains in such a state that it is placed at the bottom of the printer body 1.

In addition, if the outer diameter of the paper roll 8 is reduced as it is consumed and the paper roll 8 becomes lighter than a predetermined weight, the bottom part 9a of the hopper 9 is pivoted upward by the biasing force of the spring so that the paper roll 8 is pushed up and held.

In an alternative embodiment, the bottom part 9a of the hopper 9 may be configured so that a portion of the bottom part 9a can be pivoted. Specifically, the bottom part 9a may be formed in a comb shape, such that only a portion of the bottom part 9a is pivotably supported to push up the paper roll 8.

Next, the printing operation of the above-described printer will be described.

During the printing operation, the platen 12 is rotated and the linerless label 22 is transferred. Thus, print information is printed on the linerless label 22 by the thermal head 14. When the printed linerless label 22 is transferred by a predetermined distance, the printed linerless label 22 is cut by the cutter and is then discharged out of the printer 1.

In the printing operation, when the outer diameter of the paper roll 8 within the hopper 9 is large and thus the paper roll 8 is heavy, a large downward inertia force is applied to the paper roll 8, which makes it difficult for the paper roll 8 to rotate. Accordingly, the transfer speed of the linerless label 22 on the platen 12 may become slow, which may cause smudgy printing.

However, in this case, the damper 16 moves downward against the biasing force of the spring to cause a discharged portion of the linerless label 22 to be bent. This allows the tension of the discharged portion of the linerless label 22 to be loosened. Therefore, the transfer delay of the linerless label 22 on the platen 12 is reduced and smudgy printing is prevented.

On the other hand, if the outer diameter of the paper roll 8 is reduced by the consumption of the linerless label 22 and the paper roll 8 becomes light, the inertial force is reduced and the damper 16 is raised by the biasing force of the spring. Accordingly, the damper 16 returns back to the initial position.

Further, if the paper roll 8 becomes lighter than a predetermined weight by the consumption of the linerless label 22, the bottom part 9a of the hopper 9 is pivoted upward around the support shaft 9b by the biasing force of the spring, as indicated by solid lines FIG. 1, and pushes up and holds the paper roll 8.

As such, according to the first embodiment, if the paper roll 8 is consumed and becomes lighter than the predetermined weight, the paper roll 8 is pushed up and held by the bottom part 9a of the hopper 9. Therefore, even though the paper roll 8 is raised up to the height of the damper 16 and the adhesive coated on the roller paper 8 peels off by colliding with the guide in the vicinity of the damper 16, the problem of the damper 16 falling and colliding with the bottom or side of the hopper 9 does not occur, thereby surely preventing the generation of abnormal noise.

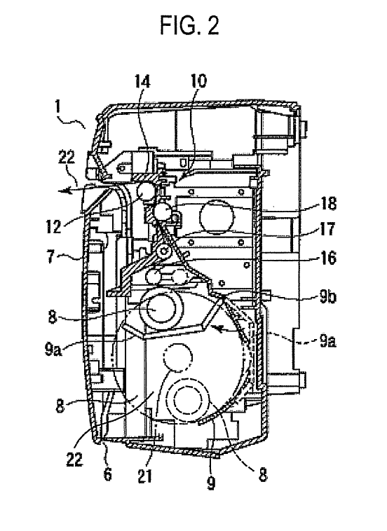

FIG. 2 is a sectional side view showing a case where the printer is installed on a wall in a vertical direction.

In this embodiment, similar to the embodiment shown in FIG. 1, if the paper roll 8 is consumed and becomes lighter than a predetermined weight, the bottom part 9a of the hopper 9 is pivoted upward around the support shaft 9b by the biasing force of the spring, as indicated by solid lines in FIG. 2, and pushes up and holds the paper roll 8. Therefore, as described above with reference to FIG. 1, it is possible to prevent abnormal noise from being generated by the fall of the paper roll 8.

In one embodiment, a cover of the above-mentioned hopper 9 may be coupled through a link mechanism (not shown) to the open/close cover 7 of the printer body 1 and pivoted to return back to the initial position in conjunction with the opening operation of the open/close cover 7.

Therefore, when loading the paper roll 8, if the open/close cover 7 of the printer body 1 is opened, the cover of the hopper may automatically return back to the initial position, and thus the cover of the hopper does not disturb the loading of the paper roll 8.

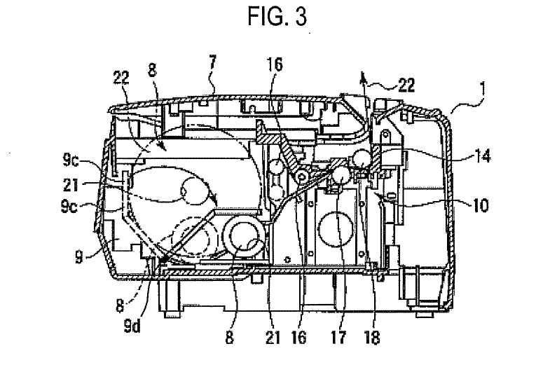

FIG. 3 shows a sectional side view showing a printer according to a second embodiment.

In FIG. 3, the same numbers are assigned to the same parts as those shown in the first embodiment, and description thereof will be omitted.

In the first embodiment described above, the bottom part 9a of the hopper 9 is pivotally installed. Alternatively, in the second embodiment, a hopper cover 9c (a holding means) of the hopper 9 is pivotally supported through a support shaft 9d. The hopper cover 9c is elastically biased by a spring (not shown) such that it can be pivoted in a direction indicated by an arrow in FIG. 3.

In the second embodiment, the hopper cover 9c keeps pressing the paper roll 8 by the biasing force of the spring. As the paper roll 8 is consumed and its outer diameter is reduced, the hopper cover 9c is pivoted. If the outer diameter of the paper roll 8 becomes less than a predetermined value, the hopper cover 9c holds the paper roll 8 by pressing the paper roll 8 toward the bottom of the hopper 9.

Similar to the first embodiment described above, the second embodiment also can prevent noise from being generated by the fall of the paper roll 8.

In addition, the hopper cover 9c may be coupled through a link mechanism (not shown) to the open/close cover 7 of the printer body 1 and pivoted to return back to the initial position in conjunction with the opening operation of the open/close cover 7.

Therefore, when loading the paper roll 8, if the open/close cover 7 of the printer body 1 is opened, the hopper cover may automatically return back to the initial position, and thus the hopper cover does not disturb the loading of the paper roll 8.

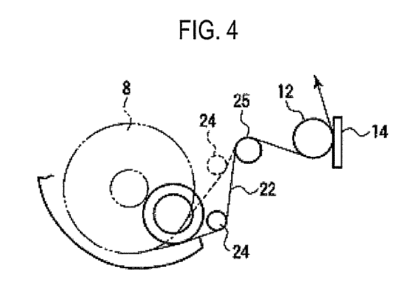

FIG. 4 is a view showing an internal configuration of a printer according to a third embodiment.

In FIG. 4, the same numbers are assigned to the same parts as those shown in the above-described embodiments, and description thereof will be omitted.

In the first embodiment described above, if the paper roll 8 is consumed and becomes light, the paper roll 8 is held by the bottom part 9a of the hopper. Also in the second embodiment, the paper roll 8 is held by the hopper cover 9c. Alternatively, in the third embodiment, the linerless label 22 is hung and held by a damper 24 (holding means) provided in a lower side of the hopper 9, such that a withdrawn portion of the paper roll 8 is bent by the damper 24, thereby loosening the tension of the linerless label 22.

In the third embodiment, when the paper roll 8 within the hopper 9 has a large outer diameter giving it significant weight, as the linerless label 22 is pulled by the rotation of the platen 12, the damper 24 moves upward against the biasing force of the spring. This facilitates the transfer of the bent portion of the linerless label 22 and reduces the transfer delay of the paper, thereby preventing smudgy printing.

In addition, if the paper roll 8 within the hopper 9 is consumed and becomes light, the damper 24 moves downward by the biasing force of the spring, as indicated by solid lines in FIG. 4, and guides the transfer of the linerless label 22.

Therefore, even though the paper roll 8 is consumed and becomes light, the upward movement of the paper roll 8 is prevented and it is possible to prevent abnormal noise from being generated by the fall of the paper roll 8, similar to the first and second embodiments described above.

Additionally, in one embodiment, the above-mentioned damper 24 may be coupled to the open/close cover 7 of the printer body 1 and move in conjunction with the opening/closing operation of the open/close cover 7.

Therefore, when the paper roll 8 is loaded and the linerless label 22 is hung on an idler roller 25 and the platen 12, if the open/close cover 7 is closed, the damper 24 can automatically push the linerless label 22 downward such that the linerless label 22 is positioned under the damper 24. This eliminates the need for any additional operation for positioning the paper roll 8 in the hopper 9.

Moreover, since the surface opposite the print surface of the linerless label 22 is an adhesive surface, double-sided printing need not be considered.

While certain embodiments have been described, these embodiments have been presented by way of example only, and are not intended to limit the scope of the inventions. Indeed, the novel printer described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer, comprising:
a printer body;
a paper roll receiving unit installed within the printer body to receive a paper roll;
a printing unit including a platen and a print head facing the platen, the printing unit configured to transfer the paper roll being withdrawn from the paper roll receiving unit by a rotation of the platen and to perform a printing operation by the print head; and
a holding unit configured to hold the paper roll at a predetermined position when the paper roll becomes lighter than a predetermined weight.

2. The printer of claim 1, wherein the holding unit includes a bottom part of the paper roll receiving unit, the bottom part being pivotable to hold the paper roll.

3. The printer of claim 1, wherein the holding unit includes a portion of a bottom part of the paper roll receiving unit, the portion of the bottom part being pivotable to hold the paper roll.

4. The printer of claim 1, wherein the holding unit includes a cover of the paper roll receiving unit, the cover being pivotable to hold the paper roll.

5. The printer of claim 4, further comprising an open/close cover configured to open and close the printer body, wherein the cover of the paper roll receiving unit is opened in conjunction with the opening operation of the open/close cover.

6. The printer of claim 1, wherein the holding unit includes a damper installed in the vicinity of the paper roll receiving unit, the damper being elastically biased toward the paper roll such that the paper roll hangs on the damper.

7. A printer, comprising:
a printer body;
a paper roll receiving unit installed within the printer body to receive a paper roll;
a printing unit configured to perform a printing operation on the paper roll being withdrawn from the paper roll receiving unit; and
a holding unit provided in the paper roll receiving unit, the hold unit configured to hold the paper roll at a predetermined position in the paper roll receiving unit when the paper roll becomes lighter than a predetermined weight.

8. The printer of claim 7, wherein the holding unit includes a bottom part of the paper roll receiving unit and a support shaft rotatably supporting the bottom part, wherein the bottom part of the paper roll receiving unit is pivoted around the support shaft to hold the paper roll at the predetermined position.

9. The printer of claim 7, wherein the holding unit includes a bottom part of the paper roll receiving unit, wherein the bottom part of the paper roll receiving unit is pivoted upward by a biasing force of a spring so that the paper roll is pushed up and held at the predetermined position.

10. The printer of claim 7, wherein the holding unit includes a cover of the paper roll receiving unit and a support shaft rotatably supporting the cover, wherein the cover of the paper roll receiving unit is pivoted around the support shaft to hold the paper roll at the predetermined position.

11. The printer of claim 10, further comprising an open/close cover that opens and closes the printer body, wherein the cover of the paper roll receiving unit is opened in conjunction with the opening operation of the open/close cover.

12. The printer of claim 7, wherein the holding unit includes a cover of the paper roll receiving unit, wherein the cover of the paper roll receiving unit is pivoted downward by a biasing force of a spring so that the paper roll is pressed downward and held at the predetermined position.

13. The printer of claim 12, further comprising an open/close cover that opens and closes the printer body, wherein the cover of the paper roll receiving unit is opened in conjunction with the opening operation of the open/close cover.
